(19) United States
(12) Patent Application Publication
(10) Pub. No.: US 2024/0408574 A1
(43) Pub. Date: Dec. 12, 2024

(54) ADSORPTION OF CARBON DIOXIDE BY SWING ADSORPTION METHODS

(71) Applicants: Avnos, Inc., Los Angeles, CA (US); University of North Texas, Denton, TX (US)

(72) Inventors: Shengqian Ma, Denton, TX (US); Bin Liang, Denton, TX (US); Benjamin A. McCool, Los Angeles, CA (US)

(21) Appl. No.: 18/612,726

(22) Filed: Mar. 21, 2024

Related U.S. Application Data
(60) Provisional application No. 63/453,501, filed on Mar. 21, 2023.

(51) Int. Cl. B01J 20/26; B01D 53/62; B01D 53/81; B01D 53/96; B01J 20/28; B01J 20/34; C08F 12/36

(52) U.S. Cl. CPC B01J 20/265; B01D 53/62; B01D 53/81; B01D 53/96; B01J 20/28023; B01J 20/28038; B01J 20/28061; B01J 20/28064; B01J 20/3425; B01J 20/3466; B01J 20/3475; C08F 12/36; B01D 2253/202; B01D 2253/306; B01D 2257/504; B01D 2259/4009; C08F 2810/00

(57) ABSTRACT

A method is provided for capturing CO₂ from a gas mixture comprising CO₂. The method includes contacting the gas mixture with a sorbent comprising a porous polymer. The porous polymer selectively binds CO₂ in the gas mixture to yield bound CO₂, thereby removing CO₂ from the gas. Upon exposure to moisture, the porous polymer releases the bound CO₂ to yield a recycled porous polymer.

### CROSS-REFERENCE TO RELATED APPLICATION

This application claims the benefit of U.S. Patent Application No. 63/453,501 filed on Mar. 21, 2023, which is incorporated by reference herein in its entirety.

### TECHNICAL FIELD

This invention relates to adsorption of carbon dioxide from a gas mixture by moisture swing adsorption.

### BACKGROUND

Capture of dispersed greenhouse gases (GHGs) is an important part of a diversified portfolio of technologies to mitigate GHG emissions. A large portion of the CO₂ emitted each year in the United States is released in relatively small quantities from distributed sources (e.g., from small point sources or some transportation sources). For such emissions, point source capture may be infeasible. In those cases, capture of dispersed CO₂ serves as a crosscutting and complementary approach to achieving economy-wide net-zero emissions.

Industrial direct air capture systems (DAC) are available. As in most current DAC systems, the CO₂ recovery process involves introduction of heat. In sorbent-based systems, the most significant exergetic losses occur from cyclic heating and cooling both the sorbent and the associated mass of heat exchange materials and structural supports. This leads to a low second law efficiency for a temperature swing adsorption (TSA) DAC system. Further, the process can require a total energy (or environmental) cost of tons of water consumed for every ton of CO₂ produced. Water consumption from deployment of conventional DAC technology has been shown to have multiple negative economic impacts offsetting the climate change mitigation benefits of DAC to a significant degree.

### SUMMARY

Methods are described herein for capturing CO₂ from a gas mixture including CO₂. In one aspect, the method includes contacting the gas mixture with a sorbent including a porous polymer, the porous polymer including a repeat unit represented by the formula:

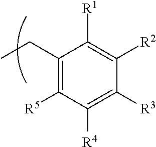

wherein each of R¹, R⁴, and R⁵ is independently H, NH₂, or a quaternary ammonium ion represented by

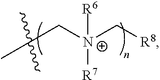

wherein each of R⁵ and R⁶ is independently a C₁-C₃ alkyl group, R⁷ is H or a C₁-C₂ alkyl group, and n is an integer from 1 to 8, wherein each of R² and R³ is independently selected from H,

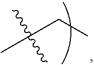 [SMILES: *CC]

or a quaternary ammonium ion represented by

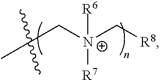

wherein at least one of R¹, R², R³, R⁴, and R⁵ is a quaternary ammonium ion,
wherein at least one of R² and R³ is

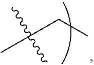 [SMILES: *CC]

wherein the porous polymer selectively binds CO₂ in the gas mixture to yield bound CO₂, thereby removing CO₂ from the gas, and upon exposure to moisture, the porous polymer releases the bound CO₂ to yield a recycled porous polymer.

In an aspect, each repeat unit is electrically neutral. In an aspect, each repeat unit comprises one or more counterions X⁻, and each X⁻ is independently OH⁻ or HCO₃⁻.

In an aspect, one of R¹, R², R³, R⁴, and R⁵ is a quaternary ammonium ion. In an aspect, two of R¹, R², R³, R⁴, and R⁵ are quaternary ammonium ions. In an aspect, three of R¹, R², R³, R⁴, and R⁵ are quaternary ammonium ions. In an aspect, four of R¹, R², R³, R⁴, and R⁵ are quaternary ammonium ions.

In an aspect, one or more of R⁶ and R⁷ is a methyl group. In an aspect, each of R⁶ and R⁷ is a methyl group, and R⁸ is H.

In an aspect, n is an integer from 1 to 3.

In an aspect, the porous polymer is deposited on a substrate. In an aspect, the substrate comprises a contactor, a porous fiber, a non-woven fibrous mat, or a combination thereof.

In an aspect, a carbon to nitrogen ratio of the repeat unit is in a range from 3:1 to 14:1.

In an aspect, a surface area of the porous polymer is in a range of about 250 m²/g to about 950 m²/g.

In an aspect, a CO₂ capacity of the porous polymer is in a range of about 0.1 mmol/g to about 3 mmol/g at about 350 to about 400 ppm CO₂.

In an aspect, within 10 minutes of exposure to the gas mixture, the porous polymer adsorbs at least 90% of a total CO₂ capacity of the porous polymer. In an aspect, within 2 minutes of exposure to the gas mixture, the porous polymer adsorbs at least 90% of a total CO₂ capacity of the porous polymer. In an aspect, within 1 minute of exposure to the gas mixture, the porous polymer adsorbs at least 90% of a total CO₂ capacity of the porous polymer.

In an aspect, a heat of adsorption of the porous polymer for CO₂ is less than 50 kJ/mol.

In an aspect, the moisture comprises liquid water, water vapor, or a gas including water vapor.

In an aspect, the method further includes contacting the recycled porous polymer with a dry gas, thereby removing excess water from the recycled porous polymer.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 shows a scheme for the synthesis of one-armed QA based ionic porous organic polymers (iPOPs) without —NH₂.

FIG. 2 shows an FT-IR spectrum of QA-POP-NH₂-p-OH dosed with CO₂.

FIG. 3 shows N₂ physisorption data for QA-POP-OH.

FIG. 4 shows CO₂ uptake of QA-POP-OH as a function of CO₂ partial pressure at 25° C.

FIG. 5 shows the isosteric heat generated by adsorbing CO₂ as a function of loading

FIG. 6 shows the uptake of CO₂ vs. time for QA-POP-OH at 25° C. and 1361 ppm CO₂.

FIG. 7 shows a scheme for the synthesis of one-armed QA based iPOPs with —NH₂.

FIG. 8A shows FT-IR spectra of QA-POP-NH₂-p-OH dosed with CO₂ (upper trace) and N₂ (lower trace). FIG. 8B shows an enlarged portion of the spectra in FIG. 8A.

FIG. 9 shows N₂ physisorption data for QA-POP-NH₂-p-OH.

FIG. 10 shows CO₂ uptake of QA-POP-NH₂-p-OH as a function of CO₂ partial pressure at 25° C.

FIG. 11 shows the isosteric heat generated by adsorbing CO₂ as a function of loading.

FIG. 12 shows the uptake of CO₂ vs. time for QA-POP-NH₂-p-OH at 25° C. and 300 ppm CO₂.

FIG. 13 shows a procedure for the synthesis of one-armed QA based iPOPs.

FIG. 14 shows an FT-IR spectrum of QA-POP-o-OH dosed with CO₂.

FIG. 15 shows N₂ physisorption data for QA-POP-o-OH.

FIG. 16 shows CO₂ uptake as a function of CO₂ partial pressure at 25° C.

FIG. 17 shows a procedure for the synthesis of two-armed QA based iPOPs.

FIG. 18 shows an FT-IR spectrum of QA2-POP-OH dosed with CO₂.

FIG. 19 shows N₂ physisorption data for QA2-POP-OH.

FIG. 20 shows CO₂ uptake as a function of CO₂ partial pressure at 25° C.

FIG. 21 shows the isosteric heat generated by adsorbing CO₂ as a function of loading.

FIG. 22 shows the uptake of CO₂ vs. time for QA2-POP-OH at 25° C. and 208 ppm CO₂.

FIG. 23 shows the conversion of one POP-2CH₂NH₂ sample.

FIG. 24 shows the CO₂ adsorption performance of a QA2-POP-OH sample derived from POP-2CH₂NH₂.

FIG. 25 shows the relationship between the CO₂ adsorption capacity at 400 ppm and the conversion ratio of QA2-POP-OH.

FIG. 26 shows a procedure for the synthesis of four-armed QA based iPOPs.

### DETAILED DESCRIPTION

The present disclosure provides a method for capturing CO₂ from a gas mixture by moisture swing adsorption. Moisture swing adsorption provides an alternative to temperature swing adsorption (TSA) for direct air capture (DCA). In moisture swing adsorption (MSA), exposure to high relative humidity results in water displacing CO₂ that had been adsorbed under dry conditions. This process can remove or reduce heat transfer requirements that limit the thermodynamic efficiency in TSA designs.

The method includes contacting the gas mixture including CO₂ with a sorbent including a porous polymer. The porous polymer selectively binds CO₂ in the gas mixture to yield bound CO₂, thereby removing CO₂ from the gas. Upon exposure to moisture, the porous polymer releases the bound CO₂ to yield a recycled porous polymer.

The porous polymer includes a repeat unit represented by the formula:

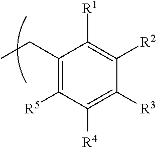

wherein:
each of R¹, R⁴, and R⁵ is independently H, NH₂, or a quaternary ammonium ion represented by

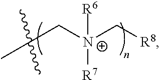

wherein each of R⁶ and R⁷ is independently a C₁-C₃ alkyl group, R⁸ is H or a C₁-C₂ alkyl group, and n is an integer from 1 to 8;
each of R² and R³ is independently selected from H,

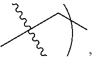 [SMILES: *CC]

or a quaternary ammonium ion represented by

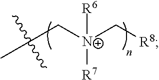

at least one of R¹, R², R³, R⁴, and R⁵ is a quaternary ammonium ion; and
at least one of R² and R³ is

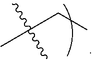 [SMILES: *CC]

As used herein in the definitions of R¹, R², R³, R⁴, and R⁵,

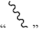

represents the point of attachment to the phenyl ring of the repeat unit.

The porous polymer includes at least one repeat unit. As used herein, parentheses ( ) refer to the point at which a repeat unit attaches to another repeat unit or a terminal functional group of the porous polymer. Parentheses are used interchangeably with

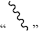

to show where one repeat unit attaches to another repeat unit or a terminal functional group of the porous polymer. In some embodiments, the porous polymer is an insoluble powder.

In some embodiments, n is an integer from 1 to 8, from 1 to 6, from 1 to 4, or from 1 to 3. In some embodiments, n is an integer from 1 to 3. In some embodiments, n is 1.

In some embodiments, one or more of R⁶ and R⁷ is a methyl group. In some embodiments, R⁸ is H. In some embodiments, each of R⁶ and R⁷ is a methyl group, and R⁸ is H.

In some embodiments, each repeat unit of the porous polymer is electrically neutral. In some embodiments, each repeat unit comprises one or more counterions X⁻. In some embodiments, each X⁻ is independently OH⁻ or HCO₃⁻.

Without wishing to be bound by theory, the quaternary ammonium ion can swing back and forth between hydroxide anion (OH⁻) and bicarbonate anion (HCO₃⁻), which has a low heat of reaction, so there is no need to manage heat evolution on adsorption. Rather, the swing can be carried out by exposing the porous polymer to moisture, which can shift the anion back to a hydroxide anion and liberate the CO₂.

In some embodiments, the repeat unit is represented by formula:

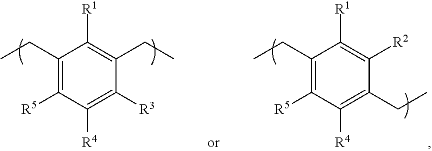

wherein R¹, R², R³, R⁴, and R⁵ are as defined herein.

In some embodiments, one of R¹, R², R³, R⁴, and R⁵ is a quaternary ammonium ion. These porous polymers may be referred to as “one-armed QA based iPOPs” herein. In some embodiments, one of R¹, R², R³, R⁴, and R⁵ is a quaternary ammonium ion, and n is an integer from 1 to 8. In some embodiments, one of R¹, R², R³, R⁴, and R⁵ is a quaternary ammonium ion, and n is 1. In some embodiments, the repeat unit has a structure selected from:

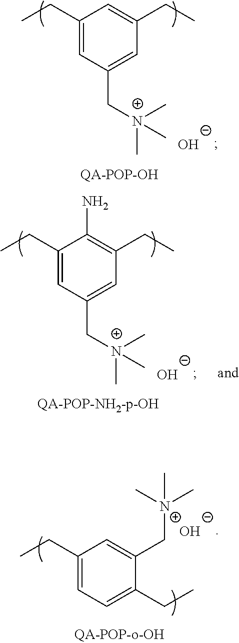

In some embodiments, two of R¹, R², R³, R⁴, and R⁵ are quaternary ammonium ions. These porous polymers may be referred to as “two-armed QA based iPOPs” herein. In some embodiments, two of R¹, R², R³, R⁴, and R⁵ are quaternary ammonium ions, and n is an integer from 1 to 6. In some embodiments, two of R¹, R², R³, R⁴, and R⁵ are quaternary ammonium ions, and n is an integer from 1 to 3. In some embodiments, the repeat unit has a structure selected from:

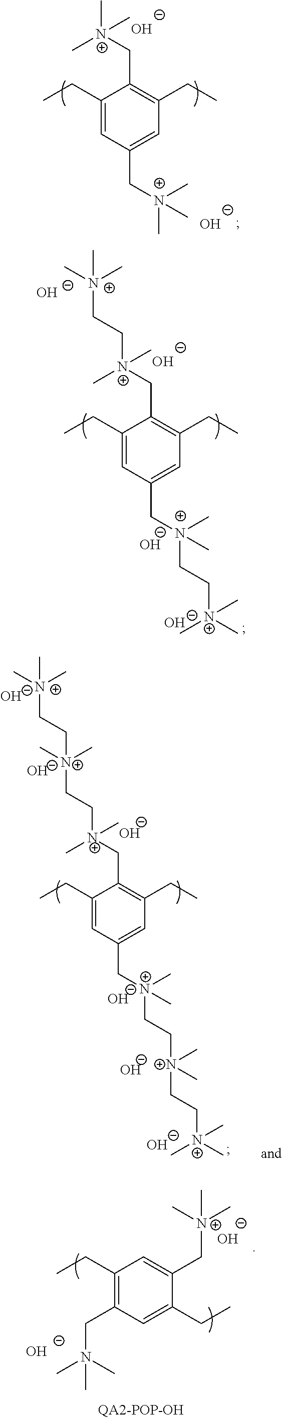

In some embodiments, three of R¹, R², R³, R⁴, and R⁵ are quaternary ammonium ions. These porous polymers may be referred to as “three-armed QA based iPOPs” herein. In some embodiments, three of R¹, R², R³, R⁴, and R⁵ are quaternary ammonium ions, and n is an integer from 1 to 4. In some embodiments, three of R¹, R², R³, R⁴, and R⁵ are quaternary ammonium ions, and n is an integer from 1 to 3. In some embodiments, the repeat unit has a structure selected from:

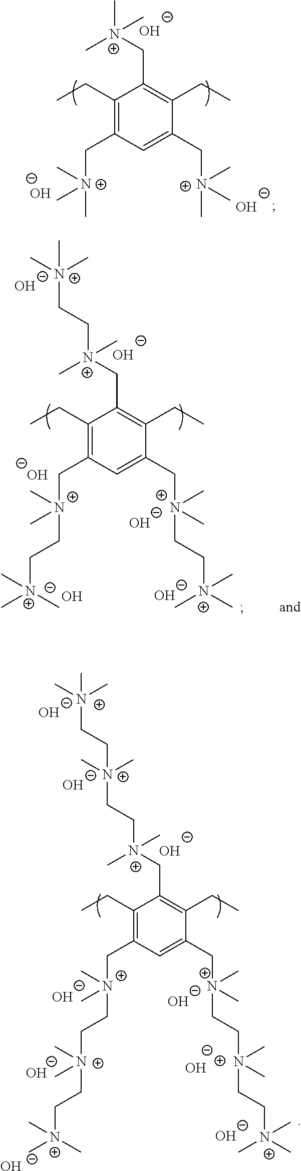

In some embodiments, four of R¹, R², R³, R⁴, and R⁵ are quaternary ammonium ions. These porous polymers may be referred to as “four-armed QA based iPOPs” herein. In some embodiments, four of R¹, R², R³, R⁴, and R⁵ are quaternary ammonium ions, and n is an integer from 1 to 4. In some embodiments, four of R¹, R², R³, R⁴, and R⁵ are quaternary ammonium ions, and n is an integer from 1 to 3. In some embodiments, the repeat unit has a structure selected from:

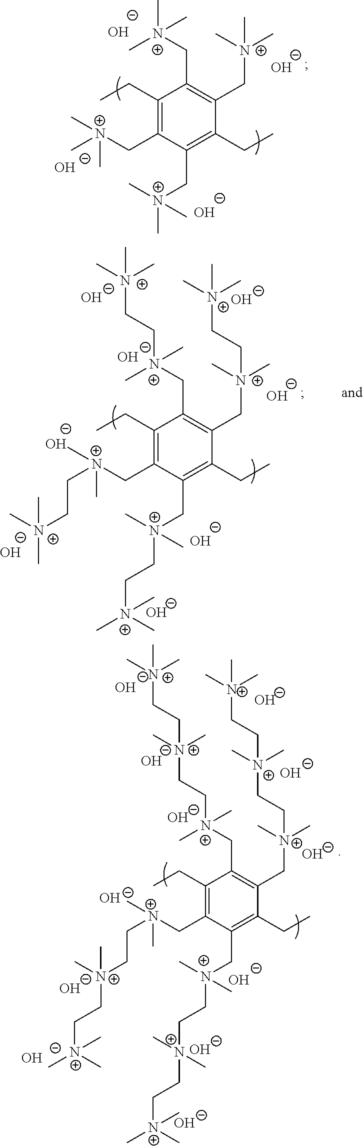

In some embodiments, a carbon to nitrogen ratio of the repeat unit is in a range from 3:1 to 18:1. In some embodiments, a carbon to nitrogen ratio of the repeat unit is in a range from 3:1 to 14:1. In some embodiments, a carbon to nitrogen ratio of the repeat unit is in a range from 4:1 to 12:1.

In some embodiments, the porous polymer is deposited on a substrate. In some examples, the substrate includes a contactor, a porous fiber, a non-woven fibrous mat, or a combination thereof.

In some embodiments, the surface area of the porous polymer is dependent on the amount of functionalization of the porous polymer (e.g., the identity of R¹, R², R³, R⁴, and R⁵). In some embodiments, the degree of functionalization of the repeat unit is selected so that the CO₂ is able to contact and bind to the N⁺ functional groups. In some cases, having too much functionalization can limit mass transport.

In some embodiments, a surface area of the porous polymer is in a range of about 250 m²/g to about 950 m²/g, about 550 m²/g to about 950 m²/g, or about 850 m²/g to about 950 m²/g. In some embodiments, a surface area of the porous polymer is about 900 m²/g. In some embodiments, a surface area of the porous polymer decreases with an increase in functionalization (e.g., an increase in the number of R¹, R², R³, R⁴, and R⁵ that are quaternary ammonium groups and/or an increase in the integer n). A high surface area adsorbent can allow for fast diffusion of CO₂ to the active sites on the porous polymer. In some embodiments, the surface area of the polymer is controlled by the degree of functionalization to achieve fast diffusion of CO₂ to the active sites of the porous polymer.

In some embodiments, a CO₂ capacity of the porous polymer is in a range of about 0.1 mmol/g to about 3 mmol/g at about 350 ppm to about 450 ppm CO₂. In some embodiments, a CO₂ capacity of the porous polymer is about 0.1 mmol/g to about 1.5 mmol/g at about 350 ppm to about 450 ppm CO₂. In some embodiments, the about 350 ppm to about 450 ppm CO₂ is in nitrogen. In some embodiments, the about 350 ppm to about 450 ppm CO₂ is in air. In some embodiments, a CO₂ capacity of the porous polymer is in a range of about 0.05 mmol/g to about 0.6 mmol/g at 400 ppm CO₂. In some embodiments, the CO₂ capacity of the porous polymer increases with the degree of functionalization of the repeat unit. In some embodiments, the CO₂ capacity of the porous polymer increases with a decreasing carbon to nitrogen ratio of the porous polymer. In one example, increasing the number of R¹, R², R³, R⁴, and R⁵ that are quaternary ammonium ions from one to two to three to four can increase CO₂ capacity of the porous polymer linearly if the degree of functionalization is constant across each quaternary ammonium ion group.

The speed at which CO₂ is bound by the porous polymer is a function at least in part of the kinetics of the reaction, the hydrodynamics of the direct air capture (DAC) system, and the morphology of the porous polymer. The hydrodynamics of the system can include, for example, gas flow rate and contactor geometry. The morphology of the polymer is related to the porosity and surface area of the polymer. In some embodiments, within 10 minutes of exposure to the gas mixture, the porous polymer adsorbs at least 90% of a total CO₂ capacity of the porous polymer. In some embodiments, within 2 minutes of exposure to the gas mixture, the porous polymer adsorbs at least 90% of a total CO₂ capacity of the porous polymer. In some embodiments, within 1 minute of exposure to the gas mixture, the porous polymer adsorbs at least 90% of a total CO₂ capacity of the porous polymer. In some embodiments, within 45 seconds of exposure to the gas mixture, the porous polymer absorbs at least 90% of a total CO₂ capacity of the porous polymer. In some embodiments, within 90 seconds of exposure to the gas mixture, the porous polymer adsorbs at least 95% of a total CO₂ capacity of the porous polymer.

The porous polymer disclosed herein can be advantageous because it has a low heat of adsorption as compared to conventional amine-based adsorbents. In some embodiments, a heat of adsorption of the porous polymer for CO₂ is less than 50 kJ/mol.

The method includes exposing the porous polymer to moisture. In some embodiments, the moisture comprises liquid water, water vapor, or a gas comprising water vapor. Exposing the porous polymer to moisture desorbs the CO₂ bound to the porous polymer.

In some embodiments, the method further includes contacting the recycled porous polymer with a dry gas, thereby removing excess water from the recycled porous polymer. In one example, the dry gas is dry air with a relative humidity below about 30%. The porous polymer can retain CO₂ capacity upon being recycled. In some embodiments, contacting the gas mixture with a sorbent comprising a porous polymer, exposing the porous polymer to moisture, and contacting the recycled porous polymer with a dry gas is repeated one or more times.

### EXAMPLES

Commercially available reagents were purchased in high purity and used without further purification.

All ¹H nuclear magnetic resonance (NMR) spectra were recorded on 400 MHz Varian NMR spectrometer in CDCl₃.

The polymerization and chemical structure of different POP-MeNH₂ samples were investigated by Fourier transform infrared spectroscopy (FT-IR; Nicolet Nexus 670, USA).

N₂ sorption isotherm measurements were conducted with the Micromeritics ASAP 2020 at 77K. The samples were outgassed for 24 h at 55° C. before the measurements.

CO₂ sorption isotherms were collected on an automatic volumetric adsorption apparatus (Micromeritics ASAP 2020 plus surface area analyzer) at 298K. The as-synthesized sample was activated at 55° C. for 24 h under ultrahigh vacuum before single-component gas adsorption to remove the guest molecules.

The binding energy of CO₂ is reflected in the isosteric heat of adsorption, Qₛₜ. The Clausius-Clapeyron equation was employed to calculate the enthalpies of CO₂ adsorption:

$$\frac{\partial ( Ln P )}{\partial ( 1 / T )} = - \frac{{Q}_{st}}{R}$$

where P is pressure, T is temperature, and Ris the universal gas constant. The adsorption heats (Qₛₜ) of the quaternary ammonium porous polymers disclosed herein (QA-POPs) for carbon dioxide were estimated using pure-component isotherms collected at 273K and 298K.

The porous polymer may be referred to as “POP” (porous organic polymer) or “iPOP” (ionic porous organic polymer).

### Synthesis of One-Armed QA Based iPOPs Without —NH₂ (QA-POP-OH)

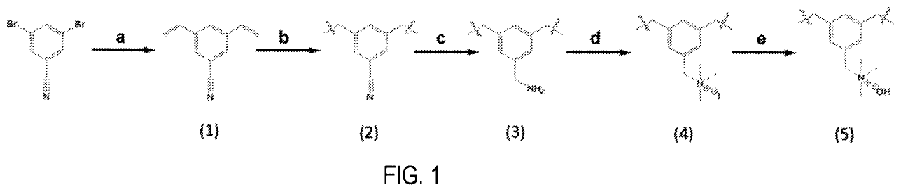

FIG. 1 shows a scheme for the synthesis of one-armed QA based iPOPs without —NH₂.

3,5-Diethenylbenzonitrile (1) 3,5-Dibromobenzonitrile (5.22 g, 20.0 mmol), potassium vinyltrifluoroborate (6.70 g, 50 mmol), and tetrakis(triphenylphosphine) palladium(0) (0.577 g, 0.50 mmol) were dissolved in a mixture of tetrahydrofuran (THF) (50 mL), toluene (50mL), and deionized water (10 mL) under N2 atmosphere. The resulting mixture was refluxed at 90° C. under N₂ atmosphere for 48 hr. The product was extracted with ethyl acetate, washed with brine, dried over magnesium sulfate, and evaporated under reduced pressure. The crude product was purified by flash chromatography with ethyl acetate:hexane (1:5) as the eluent to yield 3,5-diethenylbenzonitrile. ¹H NMR (400 MHz, CDCl₃) δ 7.56 (s, 1H), 7.52 (d, 2H), 6.6-6.7 (m, 2H), 5.75-5.84 (d, 2H), 5.35-5.42 (d, 2H) ppm.

POP-CN (2) To a solvothermal autoclave, 3,5-diethenylbenzonitrile (1 g) was combined with azobisisobutyronitrile (25 mg) and dimethylformamide (10 mL). The autoclave was placed in an oven and heated to 100° C. for 24 hr. The resulting product was collected by filtration, washed with acetone, and dried under vacuum to yield POP-CN as a brown powder.

POP-CH₂NH₂ (3) POP-CN (200 mg) was dispersed in THF (10 mL) under N₂ atmosphere. Borane-tetrahydrofuran complex (40 mL, 1 M in THF) was added in batches by a glass syringe at 0° C. Then the resulting mixture was reflux at 70° C. for 24 hr. After cooling to room temperature, pure ethanol was added dropwise to decant the excess borane. The raw POP-CH₂NH₂ powder was soaked in ethanol (100 mL) overnight. Subsequently, the powder was washed with HCl and neutralized by sodium hydroxide solution. Then the powder was washed with water. The obtained POP-CH₂NH₂ was finally dried overnight at 80° C. under vacuum.

QA-POP-I (4) The POP-CH₂NH₂ powder (200 mg) was dispersed in acetonitrile (20 mL) under N₂ atmosphere. Iodomethane (1 mL) was added at room temperature. Then the resulting mixture was refluxed at 80° C. for 24 hr. After cooling to room temperature, the raw QA-POP-I powder was washed with acetonitrile. The obtained QA-POP-I was finally dried overnight at 55° C. under vacuum.

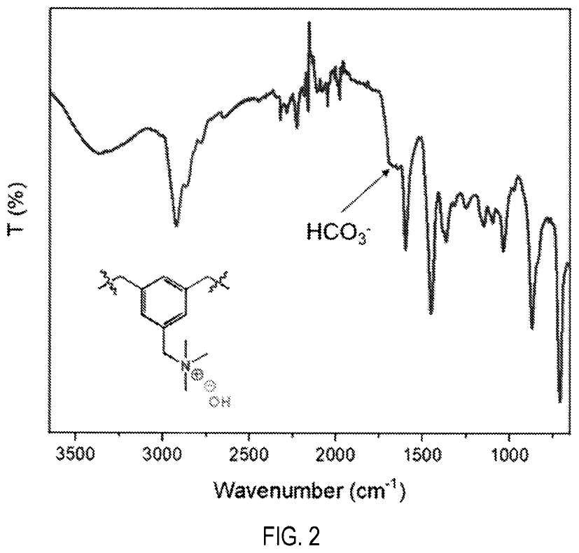

QA-POP-OH (5) The QA-POP-I powder (200 mg) was dispersed in sodium hydroxide solution (0.5 M, 10 mL) several times for ion exchange. Then the powder was washed with water and finally dried overnight at 55° C. under vacuum for CO₂ capture testing. FIG. 2 shows an FT-IR spectrum of QA-POP-OH dosed with CO₂. The indicated peak was assigned to the carbonyl stretch of a HCO₃ species generated from reaction of OH-in the QA-POP-OH with CO₂.

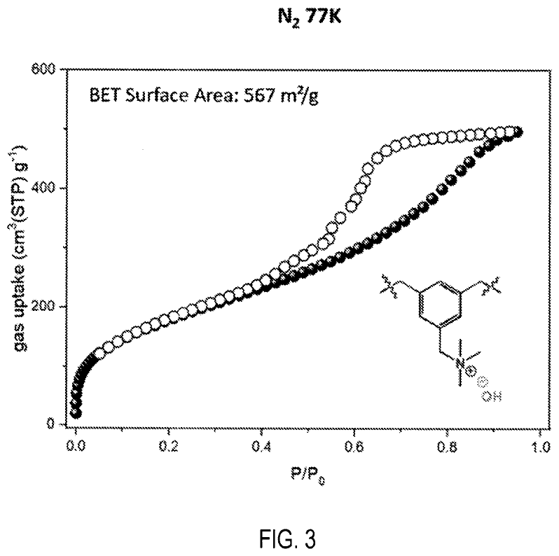

FIG. 3 shows N₂ physisorption data for QA-POP-OH. The solid circles are adsorption and open circles are desorption. The hysteresis is an indicator of mesoporosity (pore diameters between 2 nm and 20 nm).

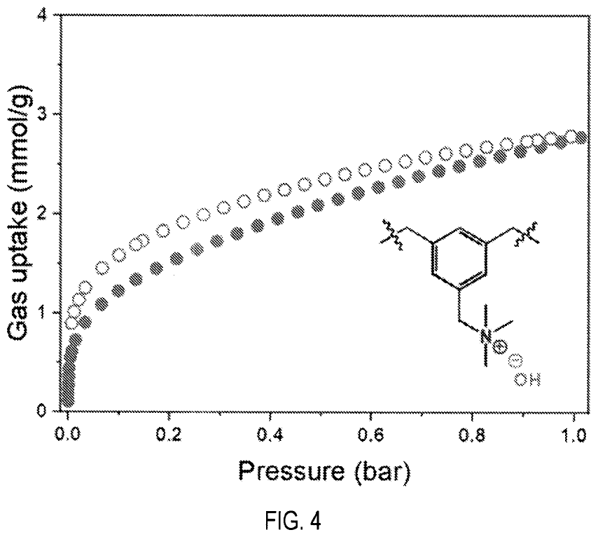

FIG. 4 shows CO₂ uptake of QA-POP-OH as a function of CO₂ partial pressure at 25° C. This material had a CO₂ capacity of 0.28 mmol/g at 400 ppm.

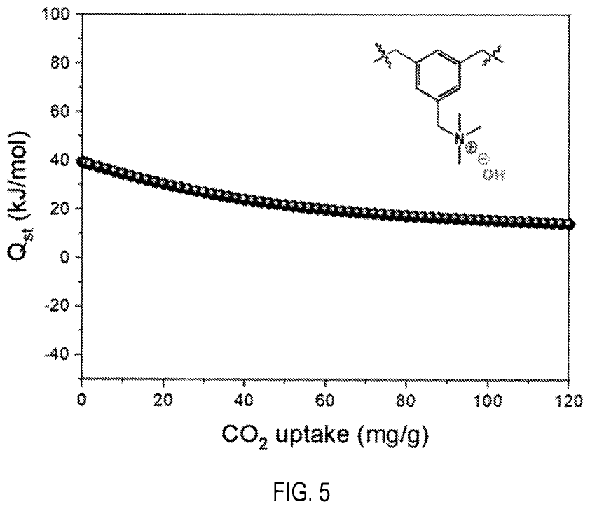

FIG. 5 shows the isosteric heat generated by adsorbing CO₂ as a function of loading.

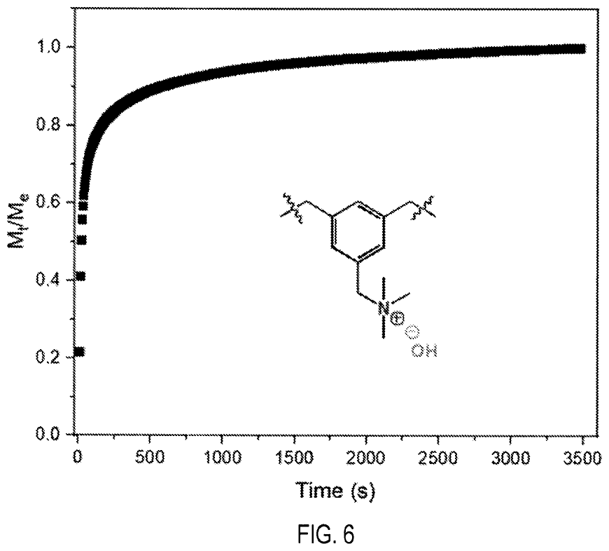

FIG. 6 shows the uptake of CO₂ vs. time for QA-POP-OH at 25° C. and 1361 ppm CO₂. The y axis is plotted as instantaneous mass vs. fully saturated (1=saturation), wherein Mₜ refers to mass uptake at time t and Mₑ refers to mass uptake at equilibrium. The material reaches 95% of saturation in about 20 minutes.

### Synthesis of One-Armed QA Based iPOPs With —NH₂ (QA-POP-NH₂-p-OH)

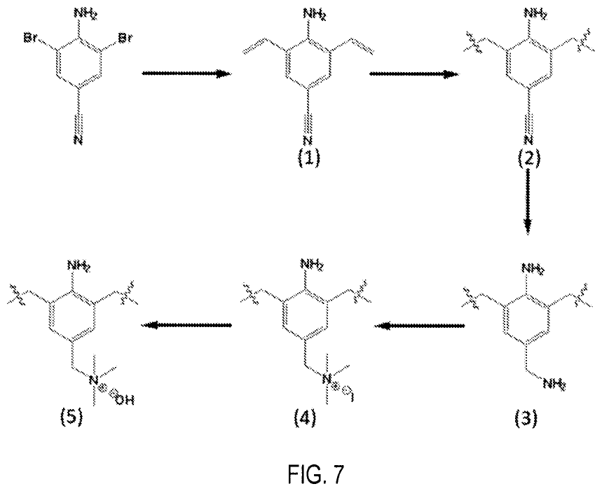

FIG. 7 shows a scheme for the synthesis of one-armed QA based iPOPs with —NH₂.

4-Amino-3,5-diethenylbenzonitrile (1) 4-Amino-3,5-dibromobenzonitrile (5.52 g, 20.0 mmol), potassium vinyltrifluoroborate (6.70 g, 50 mmol), and tetrakis(triphenylphosphine) palladium(0) (0.577 g, 0.50 mmol) were dissolved in a mixture of THF (50 mL), toluene (50 mL), and deionized water (10 mL) under N₂ atmosphere. The resulting mixture was refluxed at 90° C. under N₂ atmosphere for 48 hr. The product was extracted with ethyl acetate, washed with brine, dried over magnesium sulfate, and evaporated under reduced pressure. The crude product was purified by flash chromatography with ethyl acetate:hexane (1:5) as the eluent to yield 4-amino-3,5-diethenylbenzonitrile. ¹H NMR (400 MHz, CDCl₃) δ 7.44 (s, 2H), 6.60-6.72 (d, 2H), 5.62-5.72 (d, 2H), 5.43-5.52 (d, 2H), 4.35 (br, 2H) ppm.

POP-NH₂-p-CN (2) To a solvothermal autoclave, 4-amino-3,5-diethenylbenzonitrile (1 g) was added with azobisisobutyronitrile (25 mg) and dimethylformamide (10 mL). The autoclave was placed in an oven and heated to 100° C. for 24 hr. The resulting product was collected by filtration, washed with acetone, and dried under vacuum to produce POP-NH₂-p-CN as a brown powder.

POP-NH₂-p-CH₂NH₂ (3) POP-NH₂-p-CN (200 mg) was dispersed in the solvent of THF (10 mL) under N₂ atmosphere. Borane-tetrahydrofuran complex (40 mL, 1 M in THF) was added in batches by a glass syringe at 0° C. Then the resulting mixture was reflux at 70° C. for 24 hr. After cooling to room temperature, pure ethanol was added dropwise to decant the excess borane. The raw POP-NH₂-p-CH₂NH₂ powder was soaked in ethanol (100 mL) overnight. Subsequently, the powder was washed by HCl and neutralized by sodium hydroxide solution. Then the powder was washed by the water. The obtained POP-NH₂-p-CH₂NH₂ was finally dried overnight at 80° C. under vacuum.

QA-POP-NH₂-p-I (4) The POP-NH₂-p-CH₂NH₂ powder (200 mg) was dispersed in acetonitrile (20 mL) under N₂ atmosphere. Iodomethane (1 mL) was added at room temperature. Then the resulting mixture was refluxed at 80° C. for 24 hr. After cooling to room temperature, the raw QA-POP-NH₂-p-I powder was washed with acetonitrile. The obtained QA-POP-NH₂-p-I was finally dried overnight at 55° C. under vacuum.

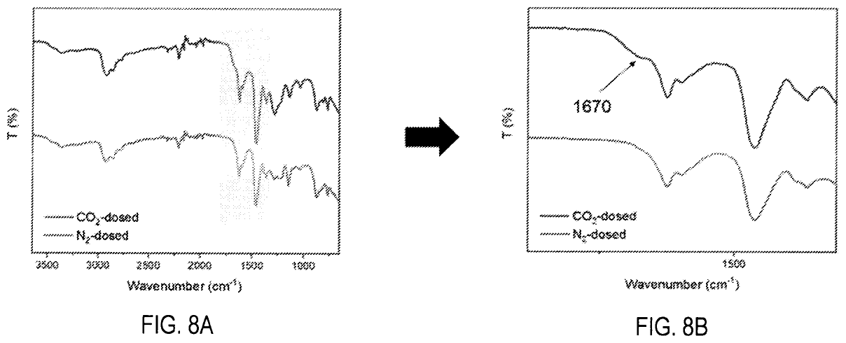

QA-POP-NH₂-p-OH (5) The QA-POP-NH₂-p-I powder (200 mg) was dispersed in sodium hydroxide solution (0.5 M, 10 mL) several times for ion exchange. Then the powder was washed with water and finally dried overnight at 55° C. under vacuum for CO₂ capture testing. FIG. 8A shows FT-IR spectra of QA-POP-NH₂-p-OH dosed with CO₂ (upper trace) and N₂ (lower trace). FIG. 8B shows an enlarged portion of the spectra in FIG. 8A. As shown in FIG. 8B, a new peak at 1670 cm⁻¹ was observed after dosing with CO₂. The new peak was assigned to the carbonyl stretch of a HCO₃⁻ species generated from reaction of OH⁻ in the QA-POP-NH₂-p-OH with CO₂.

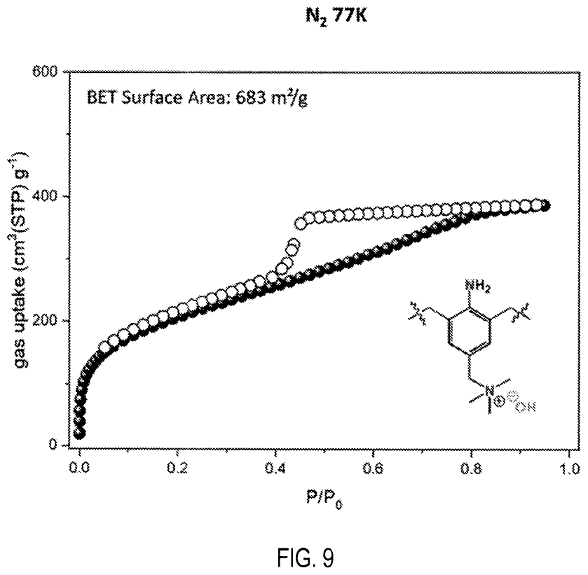

FIG. 9 shows N₂ physisorption data for QA-POP-NH₂-p-OH. The solid circles are adsorption and open circles are desorption. The hysteresis is an indicator of mesoporosity (pore diameters between 2 nm and 20 nm).

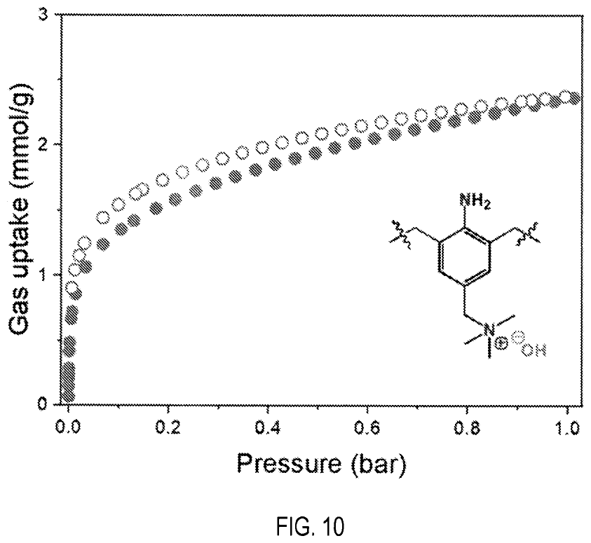

FIG. 10 shows CO₂ uptake of QA-POP-NH₂-p-OH as a function of CO₂ partial pressure at 25° C. This material had a CO₂ capacity of 0.29 mmol/g at 400 ppm.

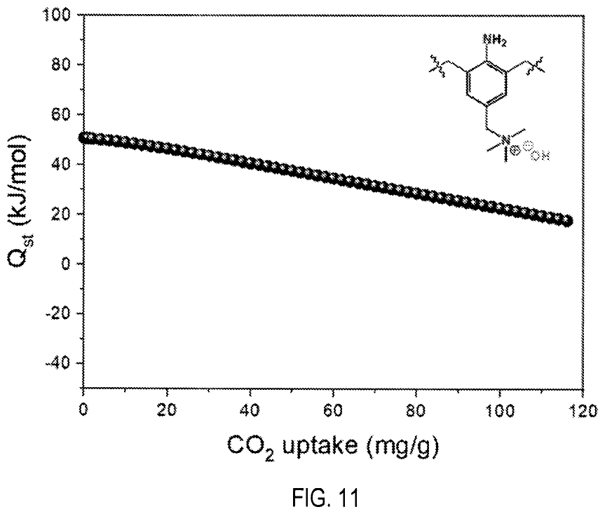

FIG. 11 shows the isosteric heat generated by adsorbing CO₂ as a function of loading.

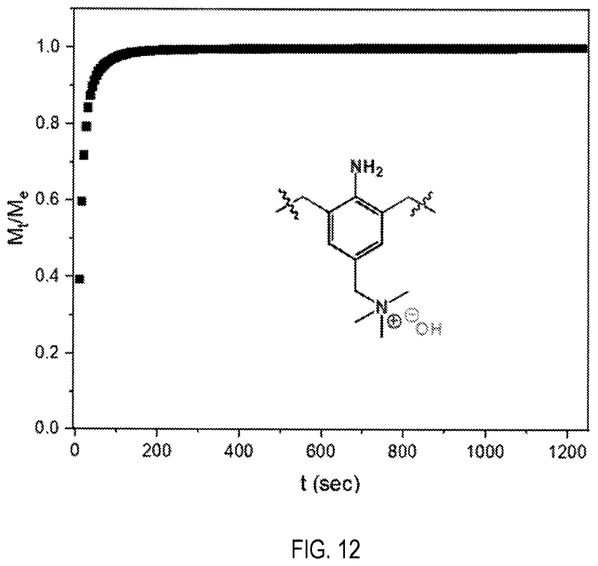

FIG. 12 shows the uptake of CO₂ vs. time for QA-POP-NH₂-p-OH at 25° C. and 300 ppm CO₂. The y axis is plotted as instantaneous mass vs. fully saturated (1=saturation). The material reaches 95% of saturation in about a minute. Compared with the QA-POP-OH, the QA-POP-NH₂-p-OH (with the existence of the —NH₂ group) exhibited much greater adsorption kinetics, which may be attributed to the cooperative CO₂ binding by the amine group and hydroxide ions.

### Synthesis of One-Armed QA Based iPOPs (QA-POP-o-OH)

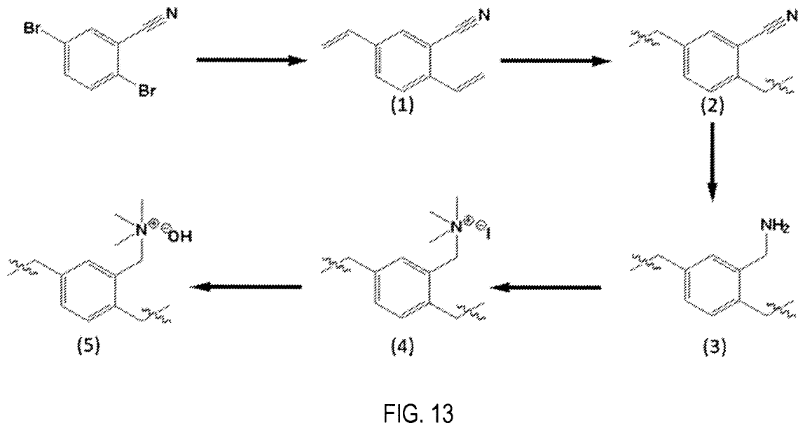

FIG. 13 shows a procedure for the synthesis of one-armed QA based iPOPs.

2,5-Diethenylbenzonitrile (1) 2,5-Dibromobenzonitrile (5.22 g, 20.0 mmol),

potassium vinyltrifluoroborate (6.70 g, 50 mmol), and tetrakis(triphenylphosphine) palladium(0) (0.577 g, 0.50 mmol) were dissolved in a mixture of THF (50 mL), toluene (50 mL), and deionized water (10 mL) under N₂ atmosphere. The resulting mixture was refluxed at 90° C. under N₂ atmosphere for 48 hr. The product was extracted with ethyl acetate, washed with brine, dried over magnesium sulfate, and evaporated under reduced pressure. The crude product was purified by flash chromatography with ethyl acetate:hexane (1:5) as the eluent to yield 2,5-diethenylbenzonitrile. ¹H NMR (400 MHz, CDCl₃) δ 7.50-7.65 (m, 3H), 6.95-7.06 (q, 1H), 6.58-6.67 (q, 1H), 5.32-5.96 (d, 4H) ppm.

POP-o-CN (2) To a solvothermal autoclave, 2,5-diethenylbenzonitrile (1 g) was added with azobisisobutyronitrile (25 mg) and dimethylformamide (10 mL). The autoclave was placed in an oven and heated to 100° C. for 24 hr. The resulting product was collected by filtration, washed with acetone, and dried under vacuum to produce POP-o-CN as a brown powder.

POP-o-CH₂NH₂ (3) POP-o-CN (200 mg) was dispersed in THF (10 mL) under N₂ atmosphere. Borane-tetrahydrofuran complex (40 mL, 1 M in THF) was added in batches by a glass syringe at 0° C. Then the resulting mixture was refluxed at 70° C. for 24 hr. After cooling to room temperature, pure ethanol was added dropwise to decant the excess borane. The raw POP-o-CH₂NH₂ powder was soaked in ethanol (100 mL) overnight. Subsequently, the powder was washed with HCl and neutralized with sodium hydroxide solution. Then the powder was washed with water. The obtained POP-o-CH₂NH₂ was finally dried overnight at 80° C. under vacuum.

QA-POP-o-I (4) The POP-o-CH₂NH₂ powder (200 mg) was dispersed in acetonitrile (20 mL) under N₂ atmosphere. Iodomethane (1 mL) was added at room temperature. Then the resulting mixture was refluxed at 80° C. for 24 hr. After cooling to room temperature, the raw QA-POP-o-I powder was washed with acetonitrile. The obtained QA-POP-o-I was finally dried overnight at 55° C. under vacuum.

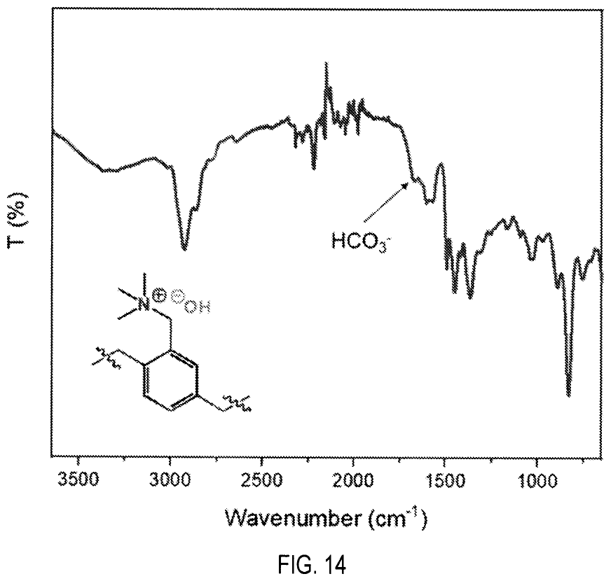

QA-POP-o-OH (5) The QA-POP-o-I powder (200 mg) was dispersed in sodium hydroxide solution (0.5 M, 10 mL) several times for ion exchange. Then the powder was washed with water and finally dried overnight at 55° C. under vacuum for CO₂ capture testing. FIG. 14 shows an FT-IR spectrum of QA-POP-o-OH dosed with CO₂. The indicated peak was assigned to the carbonyl stretch of a HCO₃ species generated from reaction of OH⁻ in the QA-POP-OH with CO₂.

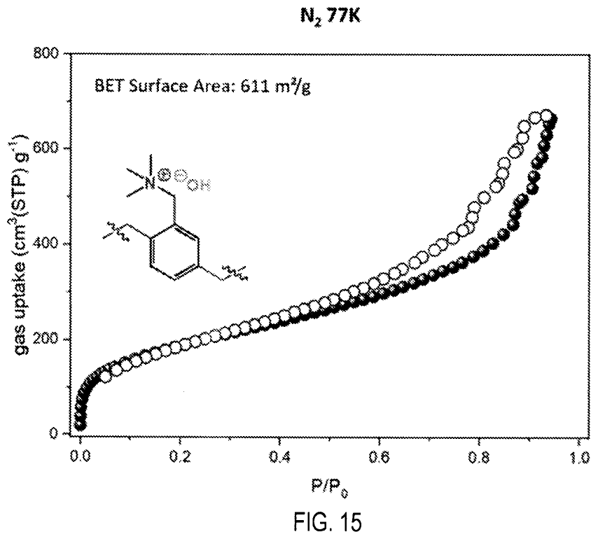

FIG. 15 shows N₂ physisorption data for QA-POP-o-OH. The solid circles are adsorption and the open circles are desorption. The hysteresis is an indicator of mesoporosity (pore diameters between 2 and 20 nm).

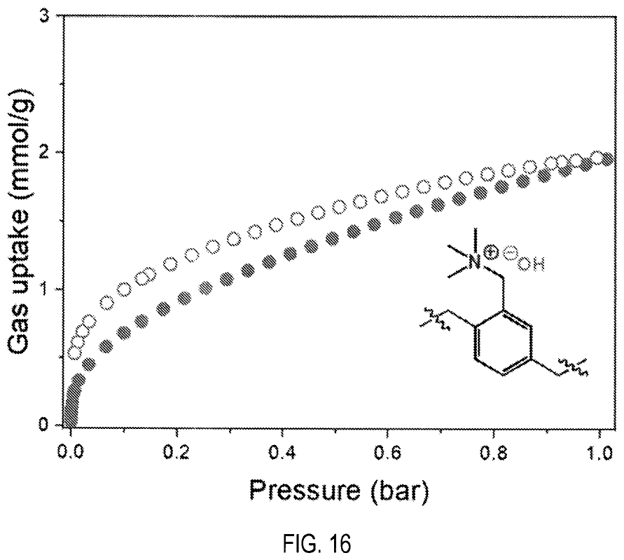

FIG. 16 shows CO₂ uptake as a function of CO₂ partial pressure at 25° C. QA-POP-o-OH had a CO₂ capacity of 0.10 mmol/g at 400 ppm.

### Synthesis of Two-Armed QA Based iPOPs (QA2-POP-OH)

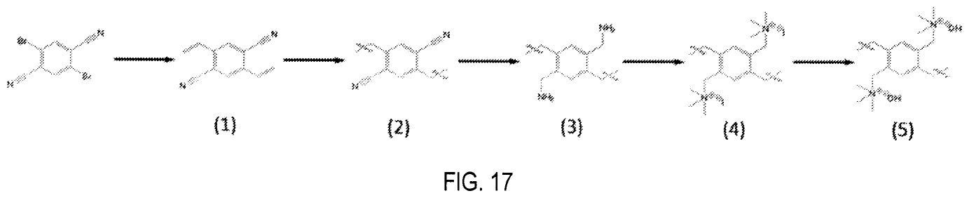

FIG. 17 shows a scheme for the synthesis of two-armed QA based iPOPs.

2,5-Diethenyl-1,4-benzenedicarbonitrile (1) 2,5-Dibromoterephthalonitrile (5.72 g, 20.0 mmol), potassium vinyltrifluoroborate (6.70 g, 50 mmol), and tetrakis(triphenylphosphine) palladium(0) (0.577 g, 0.50 mmol) were dissolved in a mixture of THF (50 mL), toluene (50 mL), and deionized water (10 mL) under N₂ atmosphere. The resulting mixture was refluxed at 90° C. under N₂ atmosphere for 48 hr. The product was extracted with ethyl acetate, washed with brine, dried over magnesium sulfate, and evaporated under reduced pressure. The crude product was purified by flash chromatography with ethyl acetate:hexane (1:5) as the eluent to yield 2,5-diethenyl-1,4-benzenedicarbonitrile. ¹H NMR (400 MHz, CDCl₃) δ 7.92 (s, 2H), 6.97-7.06 (q, 2H), 5.96-6.05 (d, 1H), 5.65-5.70 (d, 1H) ppm.

POP-2CN (2) To a solvothermal autoclave, 2,5-diethenyl-1,4-benzenedicarbonitrile (1 g) was added with azobisisobutyronitrile (25 mg) and dimethylformamide (10 mL). The autoclave was placed in an oven and heated to 100° C. for 24 hr. The resulting product was collected by filtration, washed with acetone, and dried under vacuum to produce POP-2CN as a brown powder.

POP-2CH₂NH₂ (3) POP-2CN (200 mg) was dispersed in the solvent of THF (10 mL) under N₂ atmosphere. Borane-tetrahydrofuran complex (40 mL, 1 M in THF) was added in batches by a glass syringe at 0° C. Then the resulting mixture was refluxed at 70° C. for 24 hr. After cooling to room temperature, pure ethanol was added dropwise to decant the excess borane. The raw POP-2CH₂NH₂ powder was soaked in ethanol overnight. Subsequently, the powder was washed with HCl and neutralized with sodium hydroxide solution. Then the powder was washed with water. The obtained POP-2CH₂NH₂ was finally dried overnight at 80° C. under vacuum.

QA2-POP-I (4) The POP-2CH₂NH₂ powder (200 mg) was dispersed in acetonitrile (20 mL) under N₂ atmosphere. Iodomethane (1 mL) was added at room temperature. Then the resulting mixture was refluxed at 80° C. for 24 hr. After cooling to room temperature, the raw QA2-POP-I powder was washed with acetonitrile. The obtained QA2-POP-I was finally dried overnight at 55° C. under vacuum.

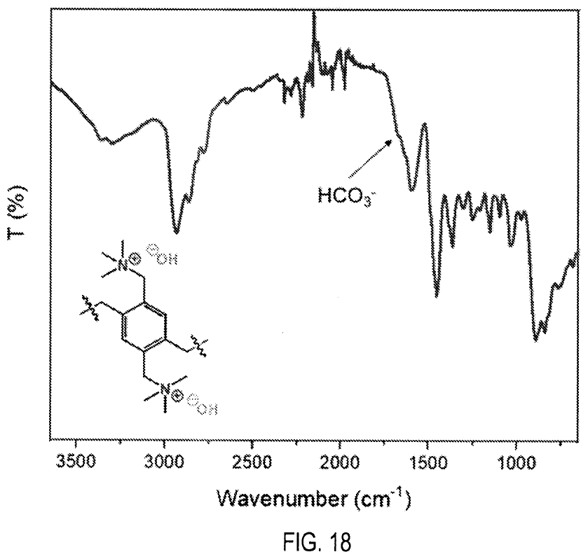

QA2-POP-OH (5) The QA2-POP-I powder (200 mg) was dispersed in the solvent of sodium hydroxide solution (0.5 M, 10 mL) several times for ion exchange. Then the powder was washed with water and finally dried overnight at 55° C. under vacuum for CO₂ capture testing. FIG. 18 shows an FT-IR spectrum of QA2-POP-OH dosed with CO₂. The indicated peak was assigned to the carbonyl stretch of a HCO₃⁻ species generated from reaction of OH⁻ in the QA2-POP-OH with CO₂.

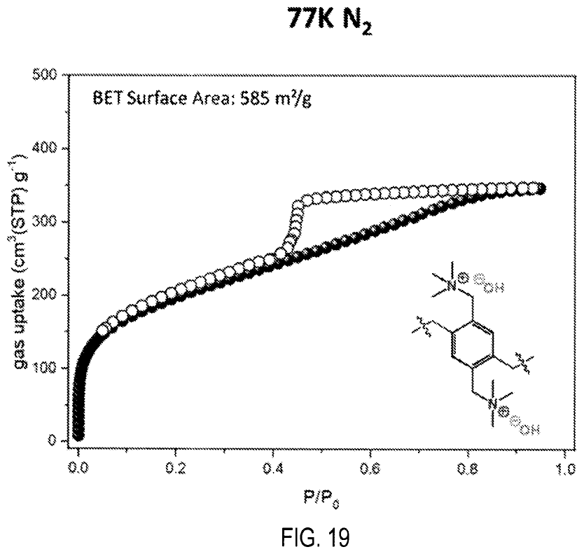

FIG. 19 shows N₂ physisorption data for QA2-POP-OH. The solid circles are adsorption and the open circles are desorption. The hysteresis is an indicator of mesoporosity (pore diameters between 2 nm and 20 nm).

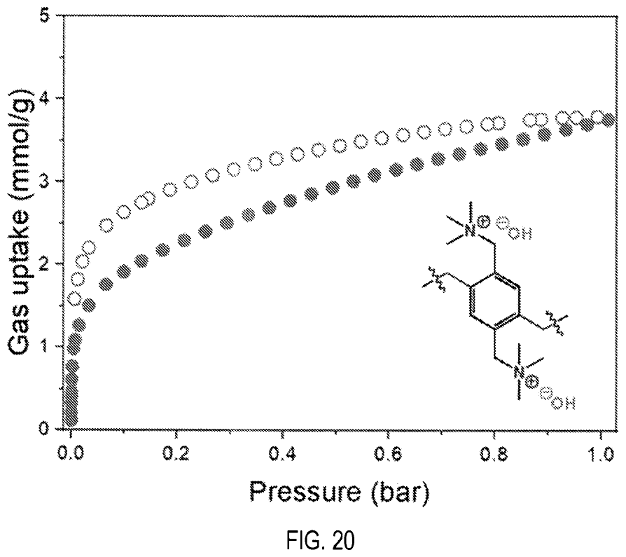

FIG. 20 shows CO₂ uptake as a function of CO₂ partial pressure at 25° C. QA2-POP-OH had a CO₂ capacity of 0.57 mmol/g at 400 ppm.

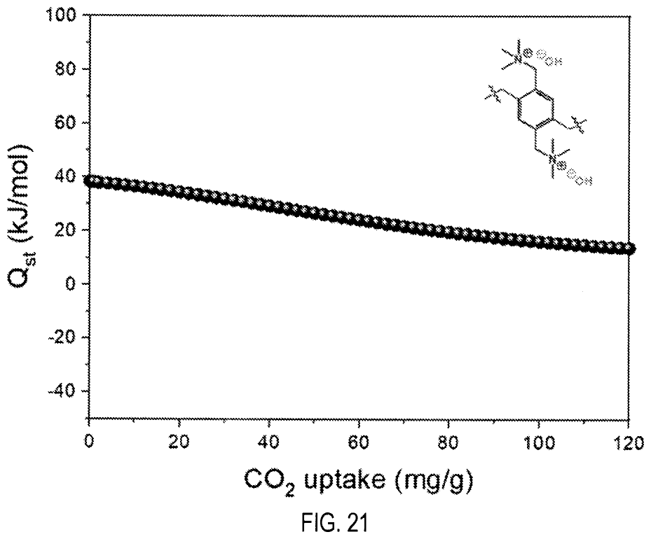

FIG. 21 shows the isosteric heat generated by adsorbing CO₂ as a function of loading.

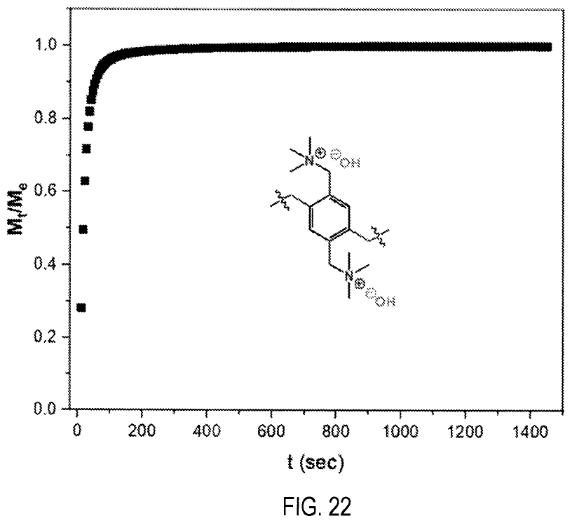

FIG. 22 shows the uptake of CO₂ vs. time for QA2-POP-OH at 25° C. and 208 ppm CO₂. The y axis is plotted as instantaneous mass vs. fully saturated (1=saturation). The material reaches 95% of saturation in about 75 seconds.

For the QA2-POP-OH, the POP-2CH₂NH₂ samples were obtained from POP-2CN by reducing the nitrile group. Then, the POP-2CH₂NH₂ samples were fully reacted with excess iodomethane and ions exchange by sodium hydroxide solution. The conversion ratio here is defined as how many nitrile groups have been reduced to the primary amine group. The reduction of nitrile groups in the POP-2CN was evaluated by the absorbance variety with IR spectra. The conversion ratio can be calculated by the equation as follows:

$$Conversion ( \% ) = \frac{{I}_{CN} ( POP - 2 {CH}_{2} {NH}_{2} )}{{I}_{CN} ( POP - 2 CN )} \times 100 \%$$

where I_{CN}(POP-2CH₂NH₂) is the strength of nitrile peak in the POP-2CH₂NH₂ samples and I_{CN}(POP-2CN) is the strength of nitrile peak in the POP-2CN sample.

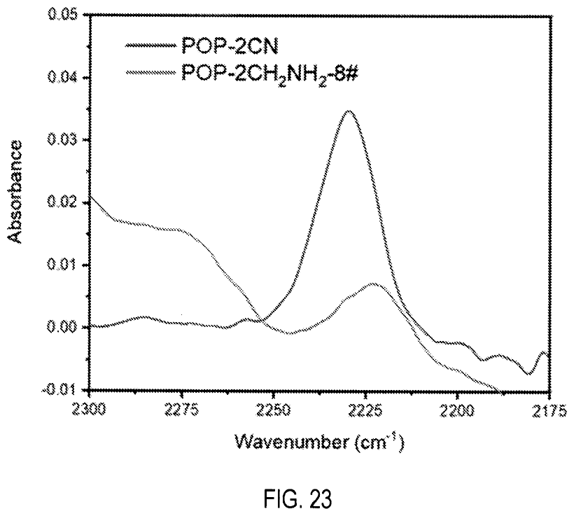

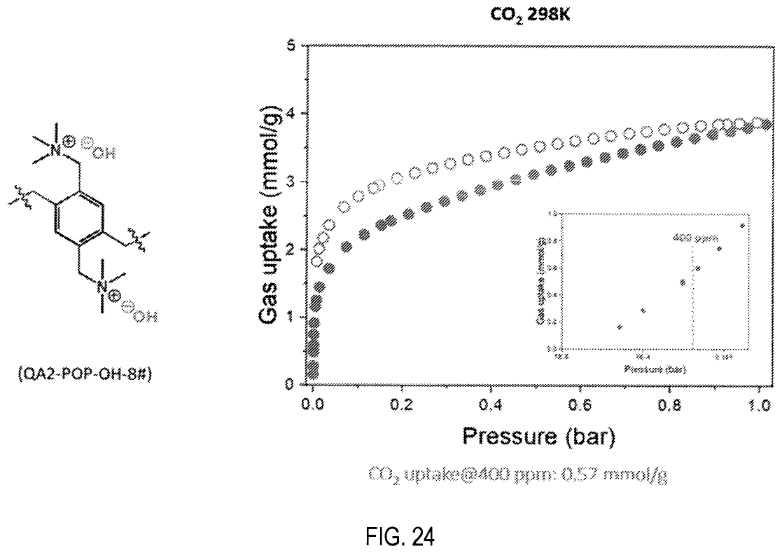

The conversion of the POP-2CN sample is zero, and the conversion of one POP-2CH₂NH₂ sample was calculated as shown in FIG. 23. From the IR spectra, the conversion ratio of nitrile for POP-2CH₂NH₂-8 # was calculated as 77.1%. The CO₂ adsorption performance of QA2-POP-OH-8 # derived from POP-2CH₂NH₂-8 #was also measured by ASAP 2020 PLUS. The results are show in FIG. 24.

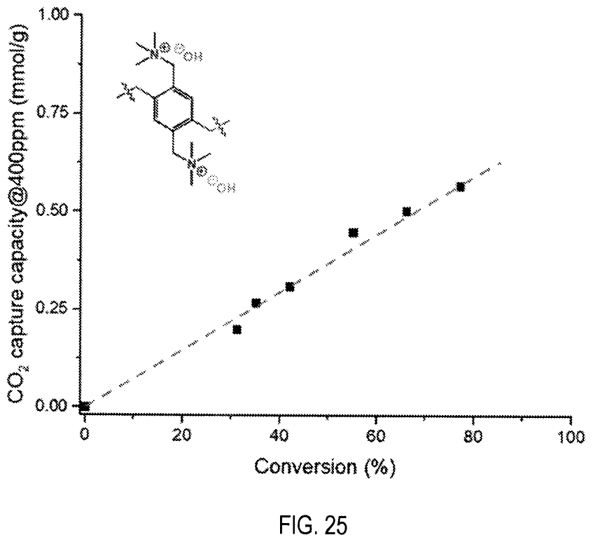

By adjusting the reduction time, the QA2-POP-OH samples with different conversion ratios were obtained. The relationship between the CO₂ adsorption capacity at 400 ppm and the conversion ratio of QA2-POP-OH is shown in FIG. 25.

### Synthesis of Four-Armed QA Based iPOPs (QA4-POP-OH)

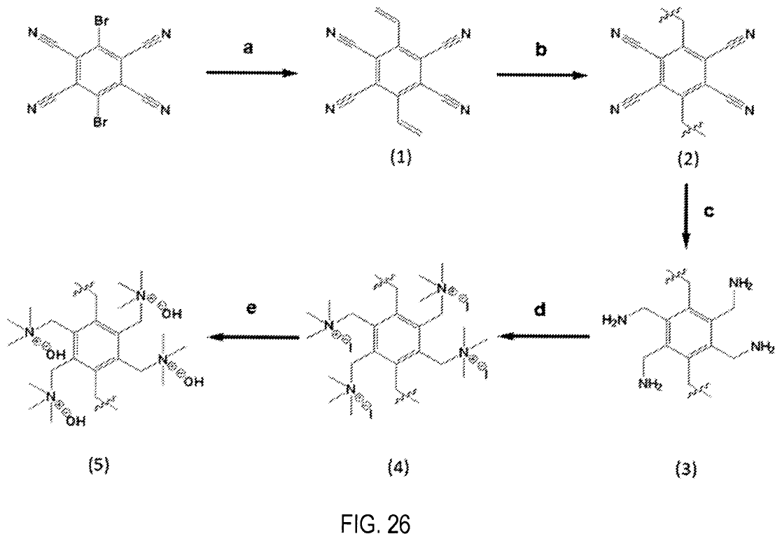

FIG. 26 shows a procedure for the synthesis of four-armed QA based iPOPs.

3,6-Diethenyl-1,2,4,5-benzenetetracarbonitrile (1) 3,6-Dibromo-1,2,4,5-benzenetetracarbonitrile (3.36 g, 10.0 mmol), potassium vinyltrifluoroborate (6.70 g, 50 mmol), and tetrakis(triphenylphosphine) palladium(0) (0.577 g, 0.50 mmol) were dissolved in a mixture of THF (50 mL), toluene (50 mL), and deionized water (10 mL) under N₂ atmosphere. The resulting mixture was refluxed at 90° C. under N₂ atmosphere for 48 hr. The product was extracted with ethyl acetate, washed with brine, dried over magnesium sulfate, and evaporated under reduced pressure. The crude product was purified by flash chromatography with ethyl acetate:hexane (1:5) as the eluent to yield 3,6-diethenyl-1,2,4,5-benzenetetracarbonitrile.

POP-4CN (2) To a solvothermal autoclave, 3,6-diethenyl-1,2,4,5-benzenetetracarbonitrile (1 g) was added with azobisisobutyronitrile (25 mg) and dimethylformamide (10 mL). The autoclave was placed in an oven and heated to 100° C. for 24 hr. The resulting product was collected by filtration, washed with acetone, and dried under vacuum to yield POP-4CN as a brown powder.

POP-4CH₂NH₂ (3) POP-4CN (200 mg) was dispersed in the solvent of THF (10 mL) under N₂ atmosphere. Borane-tetrahydrofuran complex (40 mL, 1 M in THF) was added in batches by a glass syringe at 0° C. Then the resulting mixture was refluxed at 70° C. for 24 hr. After cooling to room temperature, pure ethanol was added dropwise to decant the excess borane. The raw POP-4CH₂NH₂ powder was soaked in ethanol overnight. Subsequently, the powder was washed with HCl and neutralized with sodium hydroxide solution. Then the powder was washed with water. The obtained POP-4CH₂NH₂ was finally dried overnight at 80° C. under vacuum.

QA4-POP-I (4) The POP-4CH₂NH₂ powder (200 mg) was dispersed in acetonitrile (20 mL) under N₂ atmosphere. Iodomethane (2 mL) was added at room temperature. Then the resulting mixture was refluxed at 80° C. for 24 hr. After cooling to room temperature, the raw QA4-POP-I powder was washed with acetonitrile. The obtained QA4-POP-I was finally dried overnight at 55° C. under vacuum.

QA4-POP-OH (5) The QA4-POP-I powder (200 mg) was dispersed in sodium hydroxide solution (0.5 M, 10 mL) several times for ion exchange. Then the powder was washed by water and finally dried overnight at 55° C. under vacuum for CO₂ capture testing.

The polymerization and chemical structure of different POP-MeNH₂ samples were investigated by Fourier transform infrared spectroscopy (FT-IR; Nicolet Nexus 670, USA).

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method for capturing CO₂ from a gas mixture comprising CO₂, the method comprising:
contacting the gas mixture with a sorbent comprising a porous polymer, the porous polymer comprising a repeat unit represented by the formula: 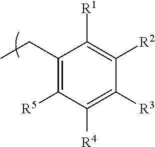
wherein each of R¹, R⁴, and R⁵ is independently H, NH₂, or a quaternary ammonium ion represented by 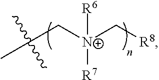
wherein each of R⁵ and R⁶ is independently a C₁-C₃ alkyl group, R⁷ is H or a C₁-C₂ alkyl group, and n is an integer from 1 to 8,
wherein each of R² and R³ is independently selected from H, 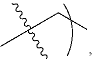 [SMILES: *CC]
or a quaternary ammonium ion represented by 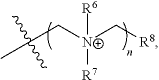
wherein at least one of R¹, R², R³, R⁴, and R⁵ is a quaternary ammonium ion,
wherein at least one of R² and R³ is 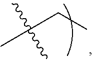 [SMILES: *CC]
wherein the porous polymer selectively binds CO₂ in the gas mixture to yield bound CO₂, thereby removing CO₂ from the gas, and
upon exposure to moisture, the porous polymer releases the bound CO₂ to yield a recycled porous polymer.

2. The method of claim 1, wherein each repeat unit is electrically neutral.

3. The method of claim 1, wherein each repeat unit comprises one or more counterions X⁻, and each X⁻ is independently OH⁻ or HCO₃⁻.

4. The method of claim 1, wherein one of R¹, R², R³, R⁴, and R⁵ is a quaternary ammonium ion.

5. The method of claim 1, wherein two of R¹, R², R³, R⁴, and R⁵ are quaternary ammonium ions.

6. The method of claim 1, wherein three of R¹, R², R³, R⁴, and R⁵ are quaternary ammonium ions.

7. The method of claim 1, wherein four of R¹, R², R³, R⁴, and R⁵ are quaternary ammonium ions.

8. The method of claim 1, wherein one or more of R⁶ and R⁷ is a methyl group.

9. The method of claim 1, wherein each of R⁶ and R⁷ is a methyl group, and R⁸ is H.

10. The method of claim 1, wherein n is an integer from 1 to 3.

11. The method of claim 1, wherein the porous polymer is disposed on a substrate.

12. The method of claim 11, wherein the substrate comprises a contactor, a porous fiber, a non-woven fibrous mat, or a combination thereof.

13. The method of claim 1, wherein a carbon to nitrogen ratio of the repeat unit is in a range of 3:1 to 14:1.

14. The method of claim 1, wherein a surface area of the porous polymer is in a range of about 250 m²/g to about 950 m²/g.

15. The method of claim 1, wherein a CO₂ capacity of the porous polymer is in a range of about 0.1 mmol/g to about 3 mmol/g at about 350 ppm to about 450 ppm CO₂.

16. The method of claim 1, wherein, within 10 minutes of exposure to the gas mixture, the porous polymer adsorbs at least 90% of a total CO₂ capacity of the porous polymer.

17. The method of claim 16, wherein, within 2 minutes of exposure to the gas mixture, the porous polymer adsorbs at least 90% of a total CO₂ capacity of the porous polymer.

18. The method of claim 17, wherein, within 1 minute of exposure to the gas mixture, the porous polymer adsorbs at least 90% of a total CO₂ capacity of the porous polymer.

19. The method of claim 1, wherein a heat of adsorption of the porous polymer for CO₂ is less than 50 kJ/mol.

20. The method of claim 1, wherein the moisture comprises liquid water, water vapor, or a gas comprising water vapor.

21. The method of claim 1, further comprising contacting the recycled porous polymer with a dry gas, thereby removing excess water from the recycled porous polymer.
